(19) United States
(12) Patent Application Publication
(10) Pub. No.: US 2026/0316790 A1
(43) Pub. Date: Oct. 15, 2026

(54) METHOD FOR OPERATING AN AUTOMATICALLY DRIVING VEHICLE

(71) Applicant: MERCEDES-BENZ GROUP AG, Stuttgart (DE)

(72) Inventors: Christian KOBETZ, Horb (DE); Konstantin FICHTNER, Sindelfingen (DE)

(21) Appl. No.: 19/482,834

(22) PCT Filed: Apr. 18, 2024
(86) PCT No.: PCT/EP2024/060495

§ 371 Date: Nov. 10, 2025

(30) Foreign Application Priority Data
May 11, 2023 (DE) 10 2023 001 905.4

(51) Int. Cl. B60W 60/00

(52) U.S. Cl. CPC B60W 60/0017; B60W 2554/4023; B60W 2554/4026; B60W 2554/406; B60W 2554/802; B60W 2720/10

(57) ABSTRACT

While a vehicle is being autonomously operated surroundings of the vehicle and objects located therein are detected using detected signals of a surroundings sensor system. A criticality of a situation present behind the vehicle is detected by the signals is classified depending on a determined vehicle class of a vehicle following the vehicle and a detected distance between the vehicle and the following vehicle.

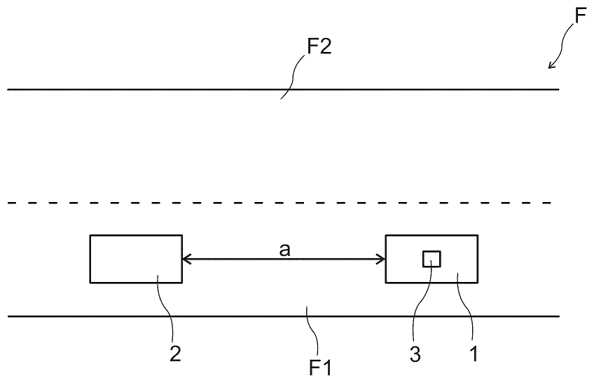

### BACKGROUND AND SUMMARY OF THE INVENTION

Exemplary embodiments of the invention relate to a method for operating an automatically driving vehicle, wherein the surroundings of the vehicle and objects located in them are detected by means of recorded signals from a surroundings sensor system.

DE 10 2013 003 215 A1 discloses a method for controlling the vehicle speed of a motor vehicle by a driver assistance system for speed control, wherein the driver assistance system is coupled to a detection device for speed-relevant traffic signs. Here, the vehicle speed is controlled by the driver assistance system to a speed whose value is set by a user by means of an input device, and this set value is stored by the driver assistance system. Upon detecting a speed-relevant traffic sign specifying a maximum permissible speed, a maximum value of the maximum permissible speed predetermined by the speed-relevant traffic sign is determined by the detection device and transmitted to the driver assistance system. The driver assistance system compares the set value with the maximum value and, if the set value is greater than the maximum value, controls the vehicle speed to the maximum permissible speed. Here, the set value determined by the driver and stored in the driver assistance system is maintained in such a way that the vehicle speed is controlled by the driver assistance system again to the set speed predetermined by the set value when a speed-relevant traffic sign is detected that overrides the permissible maximum speed.

DE 10 2014 215 274 A1 discloses a method for operating a vehicle taking into consideration a following vehicle in which a distance and a relative speed to the following vehicle are determined, and, based on the determined distance and the determined relative speed and based on a predetermined road friction coefficient and a driving speed of the vehicle, a braking path is determine which the following vehicle at least requires in order to avoid a collision with the vehicle, and that the determined braking path is compared to the determined distance and that the vehicle is guided depending on the result of this comparison in such a way that the braking path available to the following vehicle is increased.

DE 199 33 782 A1 discloses a method for avoiding rear-end collisions for a vehicle in which a distance and a relative speed to a following vehicle are determined, and, based on the determined distance, the determined relative speed, and a driving speed of the vehicle, a remaining time until the following vehicle will collide with the vehicle is calculated and, depending on the calculated time, an optical, or acoustic warning is triggered.

DE 10 2019 107 653 A1 discloses a method for determining a collision risk between two vehicles, wherein the determination of the collision risk is based on a comparison of a distance between the vehicles to a threshold value.

DE 10 2019 107 412 B3 discloses a method for distance control for a vehicle in which a distance to a vehicle driving ahead is determined, a criticality of the determined distance is determined and the determined criticality of the determined distance is taken into consideration in the distance control.

Exemplary embodiments of the invention are directed to a method for operating an automatically driving vehicle.

According to the invention, a method for operating an automatically driving vehicle, wherein the surroundings of the vehicle and objects located in them are detected by means of recorded signals from a surroundings sensor system, provides that a criticality of a situation present behind the vehicle, detected by means of the signals, is classified depending on an determined vehicle class of a vehicle following the vehicle and a detected distance between the vehicle and the following vehicle.

By using the method, it is possible to initiate various measures by the vehicle corresponding to the classified criticality in order to largely avoid, in particular, an impending rear-end collision between the vehicle and the following vehicle, based on an incorrect projection of the vehicle in relation to a vehicle driving ahead and a resulting incorrectly initiated braking of the automatically driving vehicle.

In an aspect of the method, a maximum permissible speed of the vehicle for automatic driving operation is determined depending on the classified criticality.

Here, the maximum permissible speed determined depending on the criticality represents a multi-level safety concept for the vehicle and also for the following vehicle, since the risk of a rear-end collision between the following vehicle and the vehicle, particularly due to incorrectly initiated braking of the vehicle, can thus be reduced.

In a further design, a distinction is made between a minimum criticality, a medium criticality, and a maximum criticality, whereby the multi-level safety concept is implemented. This means that a different maximum speed is permitted depending on the classified criticality of the present rear situation of the vehicle.

In a possible design of the method, determining the maximum permissible speed is carried out here in such a way that the maximum permissible speed corresponds to a predetermined maximum value when the criticality is classified as lowest and is reduced as the classified criticality increases. The maximum permissible speed for the automatic driving operation of the vehicle is thus gradually reduced depending on the criticality, such that the maximum permissible speed for the automatic driving operation of the vehicle when the highest criticality is determined is, for example, a maximum of 20 km/h, such that the following vehicle must reduce its current driving speed and, in the event of a rear-end collision that does occur, the severity of the collision between the two vehicles can thus be limited.

In a development of the method, a distinction is made between passenger cars, motorcycles, and lorries regarding the vehicle class of the following vehicle.

Distinction is made between these vehicle since a passenger car, when it is driving behind the vehicle as the following vehicle, is highly likely to pay close attention to the vehicle driving in front of it and thus initiates its own braking relatively early when the vehicle brakes in order to avoid a rear-end collision.

A driver of a motorcycle or a lorry sits higher in comparison than a driver of a passenger car, such that the driver of a motorcycle or a lorry can see over the vehicle and, due to a situation that is therefore obvious to this driver, is less likely to expect the vehicle to brake, which in turn initiates braking due to a misinterpretation of a detected object.

In an aspect, the lowest criticality regarding the detected rear situation of the vehicle is present,
when it is determined the following vehicle is a passenger car, and the distance between the vehicle and the following vehicle detected as a passenger car is more than 30 meters,
when it is determined the following vehicle is a motorcycle, and the distance between the vehicle and the following vehicle detected as a motorcycle is more than 50 meters, and
when it is determined the following vehicle is a lorry, and the distance between the vehicle and the following vehicle detected as a lorry is more than 50 meters.

The fact that the distance between the vehicle and the following vehicle detected as a passenger car is chosen to be smaller than when the following vehicle is a motorcycle or a lorry is due to the fact that substantially only the vehicle in front is in the field of vision of the driver of the passenger car, such that the driver of the passenger car can react early to a driving maneuver of the vehicle, in particular an initiated braking maneuver, in order to avoid a rear-end collision between the vehicle and the passenger car as far as possible.

In a further aspect, the highest criticality regarding the detected situation to the rear of the vehicle is present,
when it is determined that the following vehicle is a passenger car, and the distance between the vehicle and the following vehicle detected as a passenger car is less than 15 meters,
when it is determined that the following vehicle is a motorcycle, and the distance between the vehicle and the following vehicle detected as a motorcycle is less than 30 meters, and
when it is determined that the following vehicle is a lorry, and the distance between the vehicle and the following vehicle detected as a lorry is less than 30 meters.

Here, too, such a gradation regarding the distance of the following vehicle to the vehicle is chosen in such a way that a driver of a following vehicle detected as a passenger car reacts earlier to an unexpectedly initiated braking of the vehicle, since substantially only this is in the field of vision of the driver of the passenger car, than when the following vehicle is a motorcycle or a lorry.

Moreover, a design of the method provides that, when a clearing traffic jam situation is detected ahead of the vehicle, classification thresholds with respect to the average and highest criticality are increased by a predetermined value. In particular, in such a clearing traffic jam situation, a distance between vehicles driving one behind the other typically decreases, since it is thus expected that acceleration can be achieved in a timely manner.

Exemplary embodiments of the invention are explained in more detail below by means of a drawing.

### BRIEF DESCRIPTION OF THE SOLE DRAWING FIGURE

Here are shown in:

The sole drawing FIGURE, schematically, a road section with two opposing lanes and two vehicles driving one behind the other.

### DETAILED DESCRIPTION

The sole drawing FIGURES shows a road section F with two opposing lanes F1, F2, wherein two exemplary and highly simplified vehicles 1, 2 are driving one behind the other in a right lane F1.

A vehicle 1, in particular a passenger car, is driving in automated, in particular autonomous, driving mode, in which the vehicle 1 fully performs a driving task of the vehicle 1. For this purpose, the vehicle 1 has a surroundings sensor system 3 with a number of detection units (not shown) arranged in and/or on the vehicle 1. These detection units continuously detect signals during the driving operation of the vehicle 1, based on which the surroundings of the vehicle 1 and objects located therein are detected.

When detecting objects, there is the risk of erroneous projection, such that, for example, a passenger car driving ahead is recognized as a lorry, and the vehicle 1 then initiates braking that would not have been necessary. Following vehicles 2 of the vehicle 1 would therefore have to maintain a sufficiently large distance from the vehicle 1 so that the respective following vehicle 2 can brake in time if the vehicle 1 incorrectly initiates braking, to avoid a rear-end collision between the following vehicle 2 and vehicle 1.

In particular, regarding the following vehicle 2, a distinction must be made as to which vehicle class the following vehicle 2 is, since in the case of a passenger car, substantially only the preceding vehicle 1 is in the field of vision of a driver of the passenger car as the following vehicle 2.

In contrast, a driver of a motorcycle or a lorry as the following vehicle 2 can look over the vehicle 1 due to their seat height, such that the attention of the driver of the motorcycle or of the lorry as the following vehicle 2 is not only focused on the automatically driving vehicle 1 driving ahead.

If the following vehicle 2 is a motorcycle or a lorry, then a sudden braking of the vehicle 1 due to a misinterpretation of a traffic situation ahead by the vehicle 1 by the driver of the motorcycle or the lorry is more likely not expected, such that there is a risk of a rear-end collision.

Below, a method for operating the automatically driving vehicle 1 is described, which reduces the risk of a rear-end collision between the vehicle 1 and a following vehicle 2 due to incorrectly initiated braking of the vehicle 1. The method constitutes a multi-stage safety concept.

By means of the signals of the surroundings sensor system 3, the vehicle 2 following the vehicle 1 is detected, and a distance a between the vehicle 1 and the following vehicle 2 is determined.

In addition, it is determined by means of the detected signals, in particular by means of image signals of a camera of the surroundings sensor system 3, which vehicle class the following vehicle 2 is. Here, a distinction is made between the vehicle classes passenger car, motorcycle, and lorry.

By means of the determined vehicle class of the vehicle 2 following the vehicle 1 and the distance a between the vehicle 1 and the following vehicle 2, a criticality of a present situation is classified, in particular regarding when the vehicle 1 driving in automated driving mode suddenly brakes.

If it is determined that the following vehicle 2 is a passenger car, and a distance a of more than 30 meters is recorded between it and the vehicle 1, then the criticality is classified as lowest.

If the following vehicle 2 is a motorcycle or a lorry, and the distance a between the vehicle 1 and the following vehicle 2, which is recorded as a motorcycle or lorry, is more than 50 meters, then the criticality is also classified as lowest.

If the lowest criticality is present, then a maximum highest speed of, for example, 60 km/h is permitted for the automated vehicle 1.

If the following vehicle 2, recorded as a passenger car, is driving at a distance a of less than 30 meters behind the vehicle 1, the criticality is classified as medium criticality.

The present situation is also classified as medium criticality when the following vehicle 2 is a motorcycle or a lorry, and the distance a between the vehicle 1 and the motorcycle or the lorry as the following vehicle 2 is less than 50 meters. In this case, a maximum highest speed of the automatically driving vehicle 1 of 40 km/h is permitted.

The situation facing vehicle 1 regarding rear traffic is classified as having the highest criticality when the following vehicle 2 is a passenger car and the distance a between it and the automatically driving vehicle 1 is less than 15 meters.

If the following vehicle 2 is a motorcycle or a lorry and the distance a between it and the vehicle 1 is less than 30 meters, the situation is classified as having the highest criticality. If the highest criticality is present, the maximum permissible highest speed of the automatically driving vehicle 1 is limited to 20 km/h.

If, by means of signals of the surroundings sensor system 3 of the vehicle 1, it is determined that the vehicle 1 and a following vehicle 2 are in a traffic jam, wherein the traffic jam is clearing briefly and the vehicles 1, 2 are in the traffic jam again after 200 meters, then the criticality of the present situation is classified as described above. In particular, such a situation is determined by means of radar-based detection units of the surroundings sensor system 3 of the vehicle 1. If the traffic jam clears only as a temporary gap, then the speed of radar-based signals decreases at some distance from the vehicle 1, whereas the speed of radar-based signals increases at a distance if the traffic jam clears.

If, however, it is detected that the traffic jam is clearing, a distance a between vehicles 1, 2 driving one behind the other typically decreases, since it is expected that acceleration can be achieved soon. When the distance a decreases in this way, a takeover request is usually issued to a driver of vehicle 1, such that they assume the driving operation in relation to the vehicle 1.

In such a case, however, the procedure provides, in particular when a traffic jam is clearing, for increasing classification thresholds with regard to the classification of the criticality, which depends on the vehicle class of the following vehicle 2 and the distance a between the vehicle 1 and the following vehicle 2, by 20%.

For the medium criticality, this then means that it is present if a passenger car is detected as the following vehicle 2, and the distance a is less than 36 meters.

If a motorcycle or a lorry is detected as the following vehicle 2 in a clearing traffic jam, then the criticality is classified as medium criticality when the distance a between the vehicle 1 and the motorcycle or the lorry as following vehicle 2 is less than 60 meters.

By means of the method described above, the risk of a rear-end collision occurring for the automatically driving vehicle 1, in particular due to a misinterpretation of an object detected in front of the vehicle 1, can be significantly reduced.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method, comprising:
autonomously operating a vehicle;
detecting, by a surroundings sensor system of the autonomously operating vehicle, surroundings of the vehicle and objects located in the surroundings;
determining a vehicle class of a vehicle following the autonomously operating vehicle;
determining a distance between the following vehicle and the autonomously operating vehicle; and
classifying, based on the determined vehicle class of the following vehicle and the determined distance, a criticality of a situation behind the autonomously operating vehicle.

10. The method of claim 9, further comprising:
determining a maximum permissible speed of the autonomously operating vehicle for the autonomously operating of the autonomously operating vehicle depending on the classified criticality.

11. The method of claim 10, where the classification of the criticality comprises classification of the criticality as a lowest criticality, a medium criticality, and a highest criticality.

12. The method of claim 11, wherein the determination of the maximum permissible speed performed in such a way that the maximum permissible speed corresponds to a predetermined maximum value at the lowest classified criticality and is reduced with increasing classified criticality.

13. The method of claim 11, wherein the situation behind the autonomously operating vehicle is classified with the lowest criticality when
the determined vehicle class of the following vehicle is a passenger car and the determined distance between the autonomously operating vehicle and the following vehicle is more than 30 meters,
the determined vehicle class of the following vehicle is a motorcycle and the determined distance between the autonomously operating vehicle and the following vehicle detected is more than 50 meters, and
the determined vehicle class of the following vehicle is a lorry and the determined distance between the autonomously operating vehicle and the following vehicle is more than 50 meters.

14. The method of claim 11, wherein the situation behind the autonomously operating vehicle is classified with the highest criticality when
the determined vehicle class of the following vehicle is a passenger car and the determined distance between the autonomously operating vehicle and the following vehicle detected is less than 15 metres,
the determined vehicle class of the following vehicle is a motorcycle, and the determined distance between the autonomously operating vehicle and the following vehicle is less than 30 meters, and
the determined vehicle class of the following vehicle is a lorry and the distance between the autonomously operating vehicle and the following vehicle is less than 30 meters.

15. The method of claim 11, wherein, when a clearing traffic jam situation ahead of the autonomously operating vehicle is detected, classification thresholds with respect to the middle and the highest criticality are increased by a predetermined value.

16. The method of claim 9, wherein the vehicle classes comprise passenger cars, motorcycles and lorries.
